(19) United States
(12) Patent Application Publication
(10) Pub. No.: US 2004/0056640 A1
(43) Pub. Date: Mar. 25, 2004

(54) Method and device to resist sulfatizing in electric accumulators

(76) Inventor: Dag Arild Valand, Stavenger (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/450,700

(22) PCT Filed: Dec. 12, 2001
(86) PCT No.: PCT/NO01/00494

(30) Foreign Application Priority Data
Dec. 13, 2000 (NO) 20006341

(51) Int. Cl. H02J 7/04

(52) U.S. Cl. 320/139

(57) ABSTRACT

A method of reducing the build-up of lead sulphate in an electric lead/acid accumulator (1) through pulsing an electric current through the accumulator, where one or more pulse generator(s) (10) is/are electrically connected to the individual cells (4a, 4b, 4c, 4d, 4e, 4f) of the accumulator (1) by means of leads (12a, 12b, 12c, 12d, 12e, 12f, 12g). Means at pulse generator (10) for connection to an electric lead/acid accumulator, where one or more pulse generator(s) (10) is/are electrically connected to the individual cells (4a, 4b, 4c, 4d, 4e, 4f) of the accumulator (1) via leads (12a, 12b, 12c, 12d, 12e, 12f, 12g).

This invention regards a method in which current pulses are used to prevent sulphating of the pole plates in an electric lead accumulator, and means of implementing the method.

A lead/acid accumulator of the type used e.g. as a starter battery in a vehicle comprises a number of accumulator cells, an accumulator case, a lid and to terminals provided in the lid. The accumulator calls are grouped and linked, so that the voltage of the individual cells, which is around two volts, is added together in order to give the required voltage. For motor vehicles driven by internal combustion engines, the nominal accumulator voltage is normally 12 or 24 volts, whereas it may be considerably greater for electrically driven vehicles.

In order to achieve efficient chemical storage and release of energy, it is necessary to arrange two different conductive materials close to each other in a conductive liquid. The liquid is termed an electrolyte, and consists of a lead/acid accumulator of dilute sulphuric acid.

The conductive material in a lead/acid accumulator comprises a number of lead/antimony, alternatively lead/calcium plates in the form of a grid filled with a lead oxide paste. After processing and charging, the lead oxide is converted into lead peroxide in the positive plates, and into spongy lead in the negative plates.

These two materials are different electrical conductors. On discharge, the paste in both types of plates will turn into lead sulphate.

Chemically inert plate separators, preferably in the form of paper based or sintered PVC materials, are provided in the space between the stacked positively and negatively charged plates in order to prevent a short circuit between these. The plate separators must be stable in order to resist the mechanical forces that occur in an accumulator during a powerful discharge. The plate separators must also have a porous structure in order to allow efficient passage of the electrolyte.

When charging an accumulator, a direct current must be impressed in the opposite direction of the normal direction of discharge. The applied voltage must be higher than the accumulator voltage in order to make the charging current flow. During charging, the charging current will decompose the electrolyte, and the oxygen released will combine with the lead in the positive plates to form lead peroxide. Both types of plates give off sulphate that goes into the electrolyte to form sulphuric acid. As mentioned, the material in the negative plates changes into spongy lead. The process leads to a concentration of accumulator acid, whereby the specific gravity of the acid increases.

During the discharge of the accumulator, the process is reversed, as the flow of current in the accumulator leads to decomposition of the electrolyte. Sulphate passes from the electrolyte to the plates, where, upon total discharge, the lead paste has been converted to lead sulphate. Furthermore, the oxygen leaves the positively charged plates and returns to the electrolyte, where it forms water.

During a normal discharge, fine crystals of lead sulphate form on the accumulator plates. Upon charging, most of these crystals are dissolved. If the accumulator is left uncharged over a longer period of time, the fine crystals may combine to form coarser crystals that may be very difficult to reconvert back into the fine crystal type. The lead sulphate crystals block some of the pores in the porous plates, thus reducing the capacity of the accumulator. Accumulators may be damaged by a heavy build-up of crystals.

It is known that by supplying current pulses to a lead/acid accumulator, the above-mentioned formation of lead sulphate crystals may be reduced. U.S. Pat. No. 5,677,612 describes a device whereby the required energy is supplied to a multivibrator from the accumulator that is to be cleaned, and the multivibrator transmits low power/high frequency pulses into the accumulator. It is assumed that the current pulses help loosen the lead sulphate from the plates of the accumulator, allowing it to dissolve in the electrolyte.

It is also known per se, cf. U.S. Pat. No. 5,648,714, that the pulse frequency, amperage, ris time and width can be matched to the state of the accumulator. The state of the accumulator includes physical parameters such an impedance characteristics, charge status, internal electric resistance, electrolyte level, concentration of electrolyte and degree of lead sulphate build-up on the accumulator plates. According to prior art, the accumulator is monitored as one unit, and the properties of the pulses are matched to the measured values. Thus, according to prior art it is not possible to match the pulse characteristics to each individual accumulator cell.

The object of the invention is to remedy the disadvantages of prior art.

The object is achieved in accordance with the invention by the characteristics stated in the undermentioned description and in the subsequent claims.

The method entails a pulse generator of a type that is known per se being connected to each of the cells of the battery. The measuring unit of the pulse generator is designed to monitor the state of the individual cells with regard to one or more of the above-mentioned properties. The measured properties are processed in the control section of the pulse generator, and pulses that are matched with regard to pulse frequency, amperage, voltage, rise time and width are transmitted through each individual cell.

Experience goes to show that the cells in the accumulator are subjected to different loads, and controlling the pulses to each individual cell can prolong the service life of the accumulator.

A means of implementing the invention comprises a number of simple pulse generators of a type that is known per se, which are connected to each individual accumulator cell. Alternatively, a matched pulse generator may be designed to monitor all the cells of the accumulator in order then to match the pulses to each individual cell. The pulse generator(s) may be provided in or outside of the accumulator casing, or possibly in the lid of the accumulator.

The following describes a non-limiting example of a preferred embodiment illustrated in the accompanying drawing, in which;

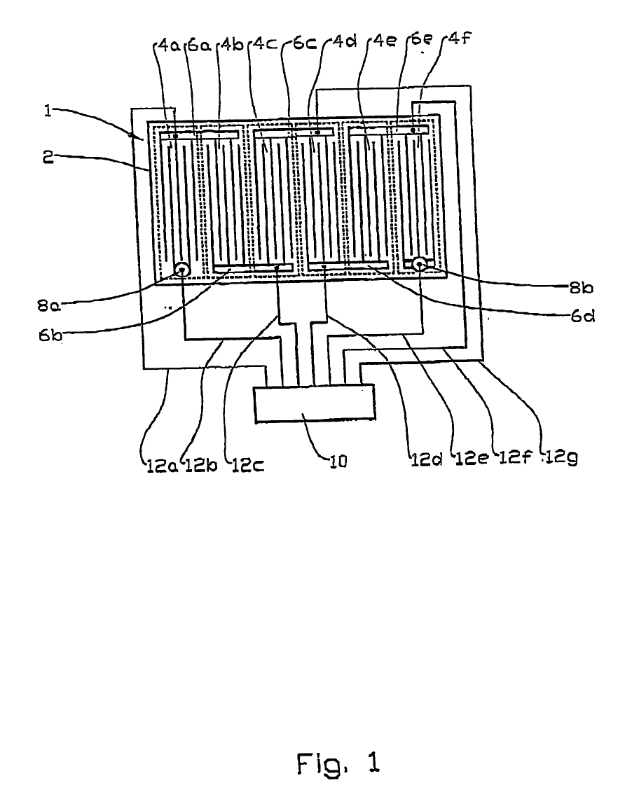

FIG. 1 shows a schematic diagram of an electric accumulator provided with a pulse generator.

In the drawing, reference number 1 denotes an electric lead/acid accumulator with a nominal output voltage of 12 volts. The accumulator 1 comprises a casing 2, accumulator cells 4a, 4b, 4c, 4d, 4e and 4f, cell connections 6a, 6b, 6c, 6d and 6e, and terminals 8a and 8b. The necessary accumulator lid with through apertures for the terminals 8a and 8b is not shown in the drawing.

A pulse generator 10 is connected via leads 12a, 12b, 12c, 12d, 12e, 12f and 12g directly to all the individual cells of the accumulator.

As described in the above general description, the pulse generator is designed to monitor each individual accumulator cell and match pulses to the state of each cell with regard to pulse frequency, amperage, voltage, rise time and width.

The method of the invention improves the matching of the pulses to the state of each individual accumulator cell, which prolongs the service life of an accumulator relative to use of prior art.

1. A method of reducing the build-up of lead sulphate in an multi cell electric lead/acid accumulator (1) through pulsing an electric current through the accumulator (1), where the state of the individual cells (4a, 4b, 4c, 4d, 4e, 4f) with regard to one or more of the parameters impedance characteristics, charge status, internal electric resistance, electrolyte level, concentration of electrolyte and degree of lead sulphate build-up on the accumulator plates, are assessed, characterised in that at least one pulse generator (10) is electrically connected to the individual cells (4a, 4b, 4c, 4d, 4e, 4f) of the accumulator (1) by means of leads (12a, 12b, 12c, 12d, 12e, 12f, 12g) and where the at least one puls generator matches the frequency of the pulses, the amperage, the voltage, the rise time and width to each individual cell (4a, 4b, 4c, 4d, 4e, 4f) without disturbing adjacent cells (4a, 4b, 4c, 4d, 4e, 4f).

2. Means at pulse generator (10) for connection to a multi cell electric lead/acid accumulator where the at least single pulse generator is designed to monitor the state of the individual cells (4a, 4b, 4c, 4d, 4e, 4f) with regard to one or more of the parameters mentioned in claim 1, characterised in that the at least single pulse generator (10) is electrically connected to the individual cells (4a, 4b, 4c, 4d, 4e, 4f) of the accumulator (1) via leads (12a, 12b, 12c, 12d, 12e, 12f, 12g).

3. Means according to claim 2, characterised in that the at least single pulse generator is designed to match the physical properties of the pulse such as described in claim 2 to the state of each individual cell (4a, 4b, 4c, 4d, 4e, 4f).
